(19) United States
(12) Patent Application Publication
(10) Pub. No.: US 2014/0094229 A1
(43) Pub. Date: Apr. 3, 2014

(54) MOBILE RADIO TERMINAL

(71) Applicant: SONY MOBILE COMMUNICATIONS JAPAN, INC., Tokyo (JP)

(72) Inventors: Yasuhiro MISHIMA, Kanagawa (JP); Hiroki Nitta, Tokyo (JP)

(73) Assignee: SONY MOBILE COMMUNICATIONS JAPAN, INC., Tokyo (JP)

(21) Appl. No.: 13/967,531

(22) Filed: Aug. 15, 2013

Related U.S. Application Data
(60) Provisional application No. 61/707,362, filed on Sep. 28, 2012.

(51) Int. Cl. H04B 1/38; H01Q 1/24

(52) U.S. Cl. CPC H04B 1/3838; H01Q 1/245
USPC 455/575.5

(57) ABSTRACT

An attitude detector installed in a cabinet detects the current attitude of the cabinet. Control circuitry suppresses radiated output power of a wireless transceiver in accordance with the current attitude of the cabinet, which is detected by the attitude detection unit. The attitude detection unit obtains two angles φ and θ based on x-axis, y-axis, and z-axis outputs of a three-axis acceleration sensor, for example. The control circuitry determines the necessity or lack thereof of the suppression of the radiated output power in accordance with a combination of the angle values.

### CROSS-REFERENCE TO RELATED PATENT APPLICATION

The present application claims the benefit of the earlier filing date of U.S. provisional application 61/707,362 having common inventorship with the present application and filed in the U.S. Patent and Trademark Office on Sep. 28, 2012, the entire contents of which being incorporated herein by reference.

### TECHNICAL FIELD

The present invention relates to a mobile radio terminal including a radio communication unit, and particularly relates to a mobile radio terminal taking measures to suppress effects of electromagnetic waves on human body and a SAR reduction method thereof.

### BACKGROUND ART

Terminals referred to as tablets, which include a display screen allowing touch input as is the case with what is referred to as a smart phone, have become available, where the display screen is larger in size than the smart phone.

Usually, a tablet includes a radio communication unit performing the transmission/reception of information via an antenna. As the radio communication unit of a mobile radio terminal, various communication schemes for a mobile phone, which include GPRS, EDGE, WCDMA/HSPA, LTE, etc., a wireless LAN, BLUETOOTH (registered trademark), and so forth are known.

At present, there are limits that are set based on an indicator referred to as the specific absorption rate (SAR) as the amount of energy absorbed by a unit mass of tissue of a human body per unit time, even though the reference value is varied among countries. Particularly, in regard to the radio communication unit of a mobile phone terminal with high output power, consideration needs to be given to such limits.

In comparison with smart phones, tablets are larger in size and weight. Therefore, when being held and used by a user, a tablet is often used near the abdomen or the chest of the user. Further, the tablet is often placed on the knees of the user for use. Accordingly, in some countries, the limits of the SAR are often set with a higher standard for the tablets.

Hitherto, techniques have been available that reduce the output power of a radio communication unit upon detecting a human body approaching or coming into contact with the mobile radio terminal using a proximity sensor installed in the terminal. These techniques reduce the SAR of the terminal resulting that the terminal conforms to the limit.

### SUMMARY OF INVENTION

According to known techniques using the above-described proximity sensor, the following problems arise.

First, since the proximity sensor is not included as an internal component in an existing mobile radio terminal, the proximity sensor needs to be additionally provided. This may lead to an increase of the cost.

Further, since the approach of a human body to an antenna causes a problem, it is preferable that the proximity sensor be provided near an antenna emitting a radio wave causing the SAR problem. However, the proximity sensor arranged near the antenna may cause a disadvantageous effect against antenna characteristics. In the past, additional measures to cope with such a disadvantageous effect were needed, that is, excessive costs and efforts were further required.

The inventors recognize the necessity of a mobile radio terminal that allows for taking measures considering the SAR without degrading antenna characteristics and requiring excessive components and costs.

A mobile radio terminal according to an embodiment of the present invention includes a cabinet, an attitude detector that is installed in the cabinet and detects a current attitude of the cabinet, a wireless transceiver that includes a transmitter and a receiver that respectively transmit and receive radio frequency signals via an antenna; and a control circuitry that suppresses radiated output power of the transmitter in accordance with a current attitude of the cabinet detected by the attitude detector.

Accordingly, the SAR is reduced in accordance with the current attitude of the cabinet, which is detected by the attitude detector (or attitude detection unit).

More specifically, the attitude detection unit includes a three-axis acceleration sensor, and the current attitude is detected based on an output of the three-axis acceleration sensor. In that case, the attitude detection unit obtains two angles φ and θ based on x-, y-, and z-axis outputs of the three-axis acceleration sensor, for example, and the control unit determines whether the control unit suppresses the output power or not in accordance with a combination of the angle values.

A SAR reduction method to be used on a mobile radio terminal according to an embodiment of the present invention includes detecting a current attitude of a cabinet of the mobile radio terminal with an attitude detector installed in the cabinet, transmitting radio frequency signals with a transmitter and an antenna and receiving radio frequency signals with a receiver and the antenna, and controllably suppressing a radiated output power of the transmitter with a control circuitry in accordance with a current attitude of the cabinet as detected by the attitude detector.

According to the present embodiment, SAR may be controlled without affecting antenna characteristics and requiring excessive components and costs.

As an attitude detection unit configured to detect the current attitude, an acceleration sensor employed in the mobile radio terminal is used, so that additional hardware component such as a proximity sensor, which is often used in existing technique, is not required. Further, since the attitude detection unit can be provided on the cabinet at any position, it becomes possible to avoid the disadvantageous effect of degrading the antenna characteristics as is the case with the proximity sensor.

A non-transitory computer readable storage medium embodiment has computer readable instructions stored thereon that when executed by a processor perform a method of reducing specific absorption rate (SAR) in a mobile radio terminal, the method includes detecting a current attitude of a cabinet of the mobile radio terminal with an attitude detector installed in the cabinet, transmitting radio frequency signals with a transmitter and an antenna and receiving radio frequency signals with a receiver and the antenna, and controllably suppressing a radiated output power of the transmitter with a control circuitry in accordance with a current attitude of the cabinet as detected by the attitude detector.

### BRIEF DESCRIPTION OF DRAWINGS

FIGS. 1A and 1B are a plan view and a side view of the outward appearance of a tablet, respectively, according to the present embodiment.

FIG. 2 is a block diagram illustrating an exemplary internal configuration of the tablet illustrated in FIG. 1.

FIG. 3 is a diagram illustrating main elements according to an embodiment of the present invention, which are exemplarily arranged in a cabinet.

FIGS. 4A and 4B are diagrams illustrating a user using the tablet and a plan view of the tablet whose four corners are marked for the sake of differentiation, respectively.

FIG. 5 is a diagram illustrating users holding the two opposite sides of the tablet with both hands in a portrait position in a portrait position and in a landscape position.

FIG. 6 is a diagram illustrating a user holding the tablet in another portrait position.

FIGS. 7A, 7B, and 7C are diagrams illustrating different attitudes of the tablet relative to a phantom provided as a virtual human body at the SAR-measuring time.

FIGS. 8A to 8D are diagrams illustrating other attitudes of the tablet relative to the phantom.

FIG. 9 is a diagram illustrating the relationship between the outputs of axes, which are obtained by a three-axis acceleration sensor installed in the tablet, and an attitude of the tablet.

FIG. 10 is a three-dimensional map diagram illustrating a global-coordinate system represented as a globe.

FIG. 11 is a diagram exhibiting a normal vector N representing an attitude of the tablet as a latitude (angle φ) and a longitude (angle θ) of the globe representing the global-coordinate system.

FIGS. 12A to 12D are diagrams that are provided to describe the longitudes of the normal vector of a display screen of the tablet.

FIG. 13 are diagrams provided to describe the latitudes of the normal vector of the display screen of the tablet according to the present embodiment.

FIG. 14 are other diagrams provided to describe the latitudes of the normal vector of the display screen of the tablet according to the present embodiment.

FIGS. 15A and 15B are still other diagrams provided to describe the latitudes of the normal vector of the display screen of the tablet according to the present embodiment.

FIGS. 16A and 16B are other diagrams provided to describe the latitudes of the normal vector of the display screen of the tablet according to the present embodiment.

FIGS. 17A and 17B are diagrams illustrating the cases where the latitude is changed at longitude 0° and longitude 180°, respectively.

FIG. 18 is a diagram illustrating the area where back-off being turned on (enabled) and the area where the back-off being turned off (disabled), which are allocated to the globe representing the global-coordinate system with the values of latitudes and longitudes as illustrated in FIG. 10.

FIG. 19 is a two-dimensional map obtained by projecting a three-dimensional map of FIG. 18 onto two-dimensional map.

FIG. 20 is a flowchart illustrating exemplary processing procedures of a control unit of the tablet according to an embodiment of the present invention.

FIG. 21 is a flowchart illustrating other exemplary processing procedures of the control unit of the tablet according to an embodiment of the present invention.

FIG. 22 is a block diagram illustrating specific functions that are provided to determine the maximum value of output power according to an embodiment of the present invention.

### DESCRIPTION OF EMBODIMENTS

Hereinafter, embodiments of the present invention will be described in detail with reference to drawings. As an exemplary mobile radio terminal, a tablet is provided below.

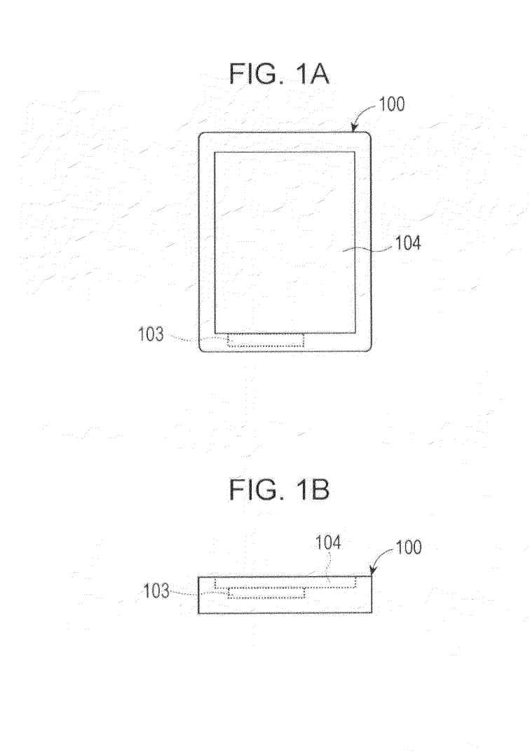

FIGS. 1A and 1B are a plan view and a side view of the outward appearance of a tablet 100, respectively, according to the present embodiment. The tablet 100 includes a display unit 104 provided on one face of a nearly rectangular cabinet 50 having a specified thickness, where the display unit 104 includes a display screen which is one size smaller than the cabinet 50. The details of the display unit 104 will be described later. An antenna 103 is provided at a specified position defined within the cabinet 50. In this example, the antenna 103 is provided along a short side of the cabinet 50. Other components of the tablet 100 will be described later.

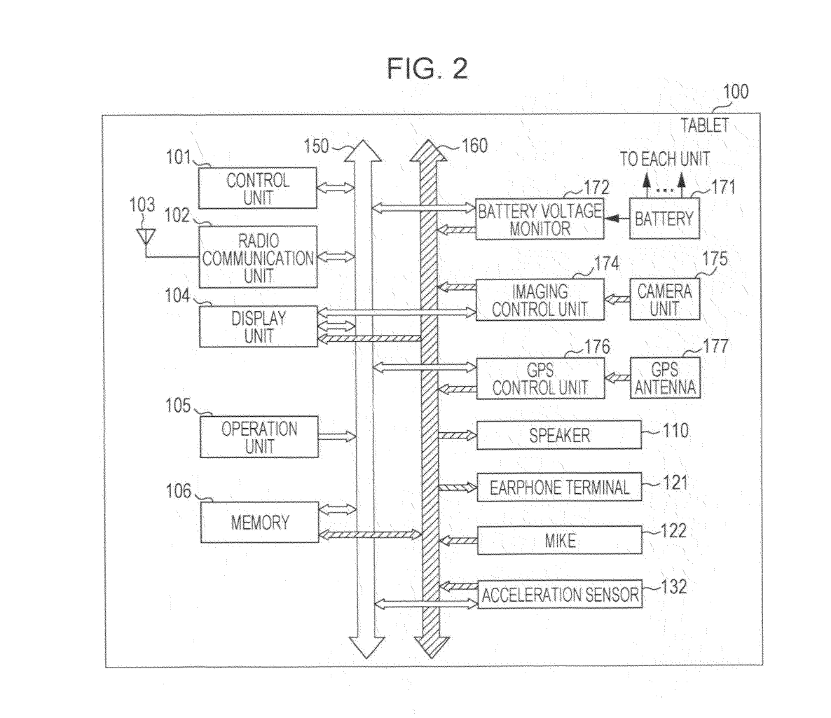

FIG. 2 is a block diagram illustrating an exemplary internal configuration of the tablet 100.

The tablet 100 has a control line 150 and a data line 160, and includes the following various function units that are connected to those lines.

A control unit (or control circuitry) 101 includes a processing unit constituted by a CPU (Central Processing Unit), etc., and performs the execution of various control programs or application programs, and the processing of various data items, which is associated therewith. According to the data processing, for example, communication control, voice processing control, and image processing control are performed. Additionally, the processing of various signals, the control of each unit, etc. are performed. In the present embodiment, particularly, the suppression of output power of a radio communication unit (described later) is performed in accordance with the attitude of the tablet (cabinet), which is detected by an attitude detection unit (or attitude detector, described later). More specifically, the maximum value of the output power is limited when the current attitude of the tablet matches a predetermined attitude condition.

A radio communication unit 102 includes a communication circuit used when the tablet 100 communicates with, for example, a radio base station of a mobile phone network. An antenna 103 is an element used when the tablet 100 performs radio communications to transmit and receive radio signals between the radio base station of a mobile phone and the tablet 100. In contrast to other antennas (a sub antenna, a wireless LAN antenna, a GPS antenna, etc.), the antenna 103 is referred to as a main antenna.

A display unit 104 is a part in charge of the display interface of the tablet 100, and includes a display device such as a liquid-crystal display unit (LCD: Liquid Crystal Display), and an organic EL display unit (OEL: Organic Electro Luminescence).

An operation unit 105 is a part in charge of an input interface provided for a user, and includes a touch panel having an input area overlapping the area of the display screen. Further, at least one hardware operation key may be included as the operation unit 105.

A memory 106 is an internal storage device including, for example, a RAM, a flash memory, etc. The flash memory is a nonvolatile memory, and nonvolatilely stores, for example, the program of an OS (Operating System), a control program enabling the control unit 101 to control each unit, various application programs, compressed and encoded track•video•still-image data content, and other various data items including the above-described data tables which will be described later. The RAM stores data at any time, as a work area used when the control unit 101 performs processing of various data items or operations.

A battery 170 supplies operation power to each unit of the tablet 100. A battery voltage monitor 172 monitors the current voltage value of the battery 170. Though not illustrated, the tablet 100 includes a charging circuit configured to charge the battery 170.

An imaging control unit 174 performs imaging control for an integrated camera unit 175.

A GPS control unit 176 functions as a position detector provided to receive a signal transmitted from a specified satellite via a GPS antenna 177, and acquire the position information of the present position.

A speaker 110 is an electroacoustic transducer provided to output a reception voice, which transduces an electrical signal into a voice. An earphone terminal 121 is a jack the plug of an earphone can go into.

A microphone unit (mike) 122 is a device provided to output a transmission voice, which transduces a voice into an electrical signal.

An acceleration sensor 132 is a device provided to measure acceleration in three orthogonal axes, which can detect the direction of gravity occurring due to the current attitude of the tablet 100 (the cabinet 50) where it is integrated, that is, a gravity vector G, in a stationary state. The current attitude of the tablet 100 can be perceived based on the current gravity vector G.

Incidentally, each of the components that are illustrated in FIG. 2 is not essential for the present invention. The tablet 100 may further include various structural components that are provided in existing mobile terminals, which are not illustrated in FIG. 2.

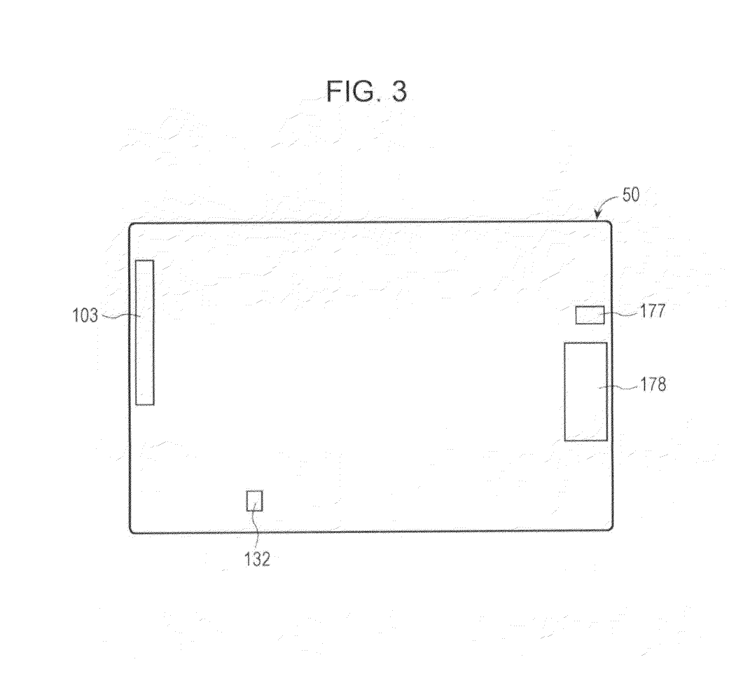

FIG. 3 illustrates main elements of the present embodiment, which are exemplarily arranged in the cabinet 50. The diagram illustrates the back face (a face where the display screen is not provided) of the tablet 100. The main antenna 103 is arranged along a short side of the cabinet 50 (the left end of the diagram). The acceleration sensor 132 is arranged near a long side (the lower end of the diagram). The GPS antenna (also serves as the antenna of a wireless LAN) 177 is arranged near the short side opposite to the main antenna 103 (the right end of the diagram). Though not illustrated in FIG. 2, a sub-antenna 178 is arranged on the short side opposite to the main antenna 103 and is adjacent to the GPS antenna 177.

Those components are arranged just for the sake of exemplification, and the present invention is not limited to the arrangement positions.

Hereinafter, operations of the tablet 100, which are performed according to the present embodiment, will be described.

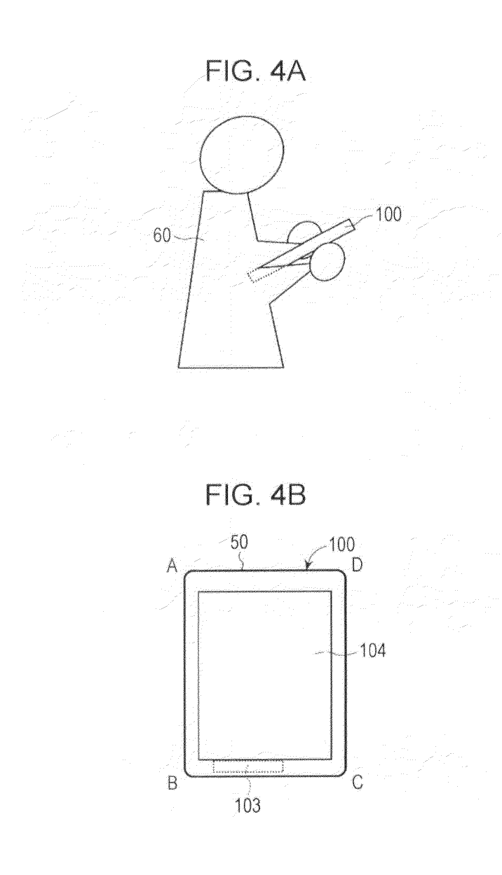

FIG. 4A illustrates a user 60 holding the tablet 100 with both hands and views the screen of the display unit 104. FIG. 4B is a plan view of the tablet 100 whose four corners are marked with alphabets A, B, C, and D. This enables differentiating between the four corners of the cabinet 50 when the substantially rectangular tablet 100 is viewed from the front.

In the present embodiment, basically, the acceleration sensor 132 is used as an attitude detection unit detecting the current attitude of the tablet 100 (that is, the cabinet 50) without using a proximity sensor. Then, it is confirmed whether or not the current attitude of the tablet 100, which is detected by the acceleration sensor 132, is an attitude assumed when the user may use the tablet 100 in ordinary cases. When the attitude is assumed, the control unit 101 performs the suppression of output power of the radio communication unit 102.

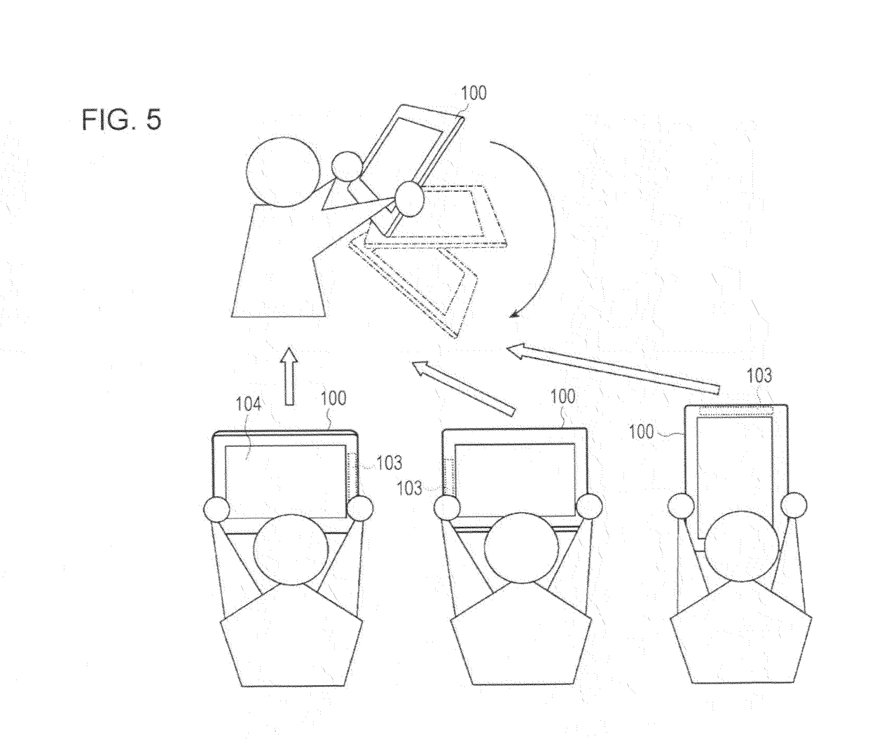

In FIG. 5, an attitude of the tablet 100 is assumed in the state of being used by the user, and, in the situation, the user holds the two opposite sides of the tablet 100 with both hands. In this specification, the status where the rectangular cabinet 50 of the tablet 100 is longitudinally held is referred to as a portrait position, and the status where the cabinet 50 is laterally held is referred to as a landscape position. Usually, in that case, an expected attitude of the tablet 100 is assumed in the state of being vertically rotated within a specified angle range with reference to the display screen being in an upward-and-horizontal state. The attitude range of FIG. 5 includes the case where the tablet 100 is held in the landscape position so that the antenna 103 is on the left side or the right side and the case where the tablet 100 is held in the portrait state so that the antenna is on the far side. Further, the state where the tablet 100 is not held with both hands, but placed on the knees (thighs) of the user is also included.

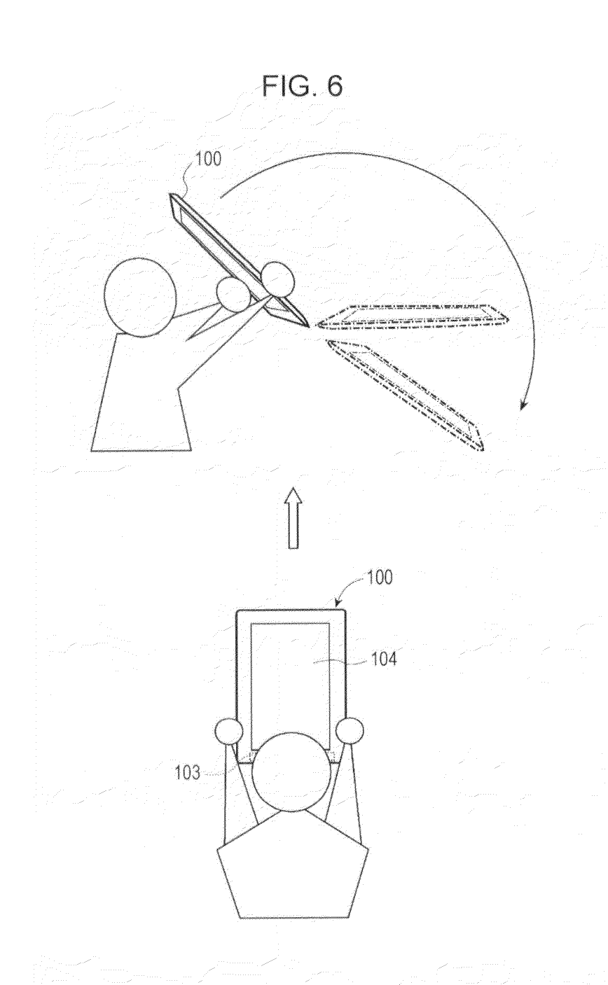

FIG. 6 illustrates another situation where the user holds the tablet 100 in the portrait position with both hands and views the screen of the display unit 104. In that case, the state where the antenna 103 of the tablet 100 is arranged along a short side which is near the user, and the display screen is directed diagonally downward beyond the angle range of FIG. 5 and looked up at is also included. Even in the state where the user sits in a reclining chair or the like, holds the tablet 100 with hands, and looks up at the display screen, the lower-end part of the tablet 100 often comes into contact with or approaches a human body (the thigh, the abdomen, and so forth of the user). The above-described additional angle is determined in consideration of such a situation.

Thus, in the present embodiment, the suppression of output power of the radio communication unit 102 is performed in the attitude state where the tablet 100 is estimated to be in a state of being used by the user. A specific method of suppressing the output power will be described later. In this specification, an operation performed to suppress the output power is referred to as “back-off (back off)”. Further, performing the suppression operation is referred to as turning on, or enabling the back-off, and not performing the suppression operation is referred to as turning off, or disabling the back-off.

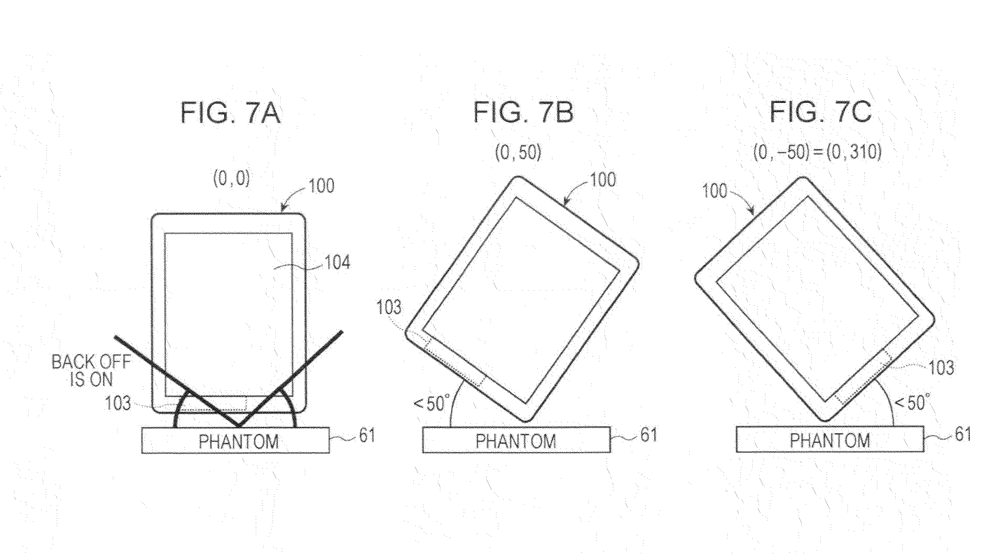

FIGS. 7A, 7B, and 7C illustrate different attitudes of the tablet 100 relative to a phantom 61 provided as a virtual human body, which are expected at the SAR-measuring time. Parentheses that are added to the tablets assuming the attitudes of the diagrams represent the combinations of latitude values and longitude values that will be described later, which correspond to the attitudes.

The status of FIG. 7A is determined to be an initial status used as the reference, and the back-off is turned on within the range of gradients (in this case, 50° or less) of FIGS. 7B and 7C. The range is determined considering that a probability that the antenna 103 approaches the human body is high.

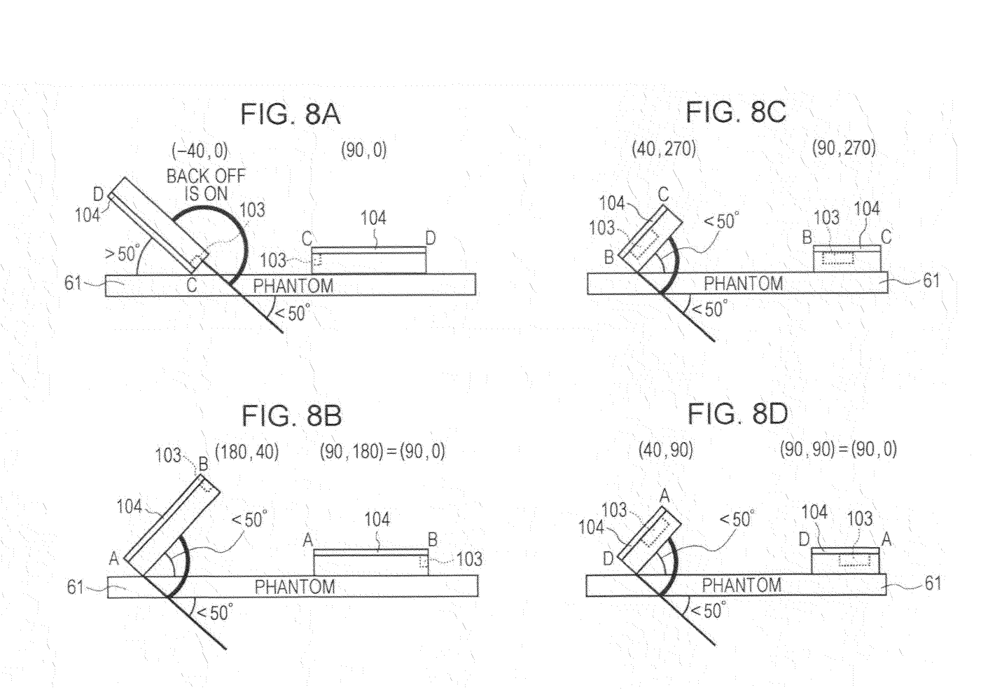

FIGS. 8A to 8D illustrate other types of attitudes of the tablet 100 to the phantom 61. Parentheses of the diagrams also represent the combinations of latitude values and longitude values, which correspond to the attitudes.

FIG. 8A illustrates the case where the tablet 100 is in the portrait position in regard to the phantom 61, and the main antenna 103 is positioned on the phantom 61's side. Short side BC of the tablet 100 is positioned on the phantom 61's side. In that case, the back-off is turned on when the display screen falls within the range of angles of from −50° to 130° relative to the horizontal.

FIG. 8B illustrates the case where the tablet 100 is in the portrait position in regard to the phantom 61, and the main antenna 103 is positioned on the side opposite to the phantom 61. Short side AD of the tablet 100 is positioned on the phantom 61's side. In that case, the back-off is turned on when the display screen falls within the range of angles of from −50° to 50° relative to the horizontal.

FIG. 8C illustrates the case where the tablet 100 is in the landscape position in regard to the phantom 61, and the main antenna 103 is positioned on a lateral side (in this case, the right side of the tablet as viewed from the side opposite to the display screen). Long side AB of the tablet 100 is positioned on the phantom 61's side. In that case, the back-off is turned on when the display screen falls within the range of angles of from −50° to 50° relative to the horizontal.

FIG. 8D illustrates the case where the tablet 100 is in the landscape position in regard to the phantom 61, and the main antenna 103 is positioned on a lateral side (in this case, the left side of the tablet as viewed from the side opposite to the display screen). Long side CD of the tablet 100 is positioned on the phantom 61's side. In that case, the back-off is turned on when the display screen falls within the range of angles of from −50° to 50° relative to the horizontal.

In any of FIGS. 8A to 8D, the range where the back-off is turned on is a range where a probability that the antenna 103 approaches the human body is expected to be high.

Incidentally, even though an attitude falling within the range where a probability that the antenna 103 approaches the human body is expected to be high is assumed, the main antenna may not necessarily approach the user, because the tablet is placed on a desk, for example. In such a case, the necessity or lack thereof of the back-off is uniformly determined based on the attitude of the tablet (that is, the output of the acceleration sensor).

Next, a specific method of detecting the attitude of the tablet 100 will be described.

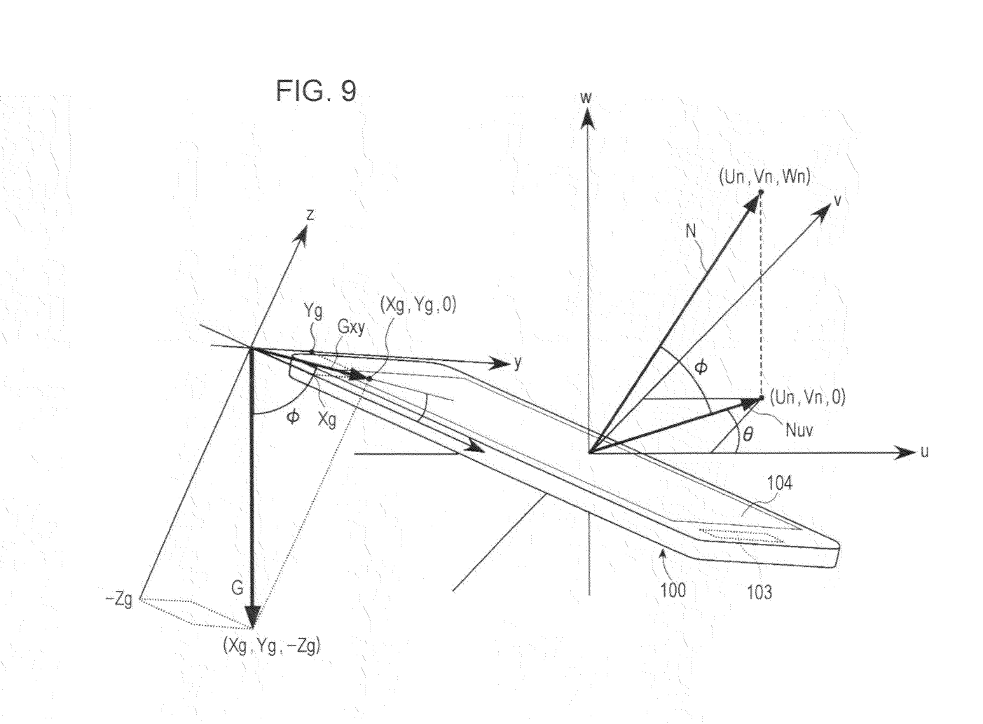

FIG. 9 illustrates the relationship between the outputs of axes, which are obtained by an acceleration sensor that is provided for three axes x, y, and z, and that is installed in the tablet 100, and the attitude of the tablet 100. Further, the relationship between a coordinate system (sensor-coordinate system: x, y, and z) to which the axes of the acceleration sensor belong and the coordinate system of space where the tablet 100 is placed (global-coordinate system: u, v, and w) is also illustrated. In this example, with regard to the three-axis acceleration sensor, the direction of a long side of the tablet 100 (the cabinet 50) is determined to be an x-axis, the direction of a short side is determined to be a y-axis, and an axis orthogonal to both of the axes is determined to be a z-axis. A direction perpendicular to the display screen of the display unit 104 (the direction of a normal vector) agrees with the z-axis positive direction. The gravity vector G indicates a vertically downward direction. The direction of the gravity vector agrees with the w-axis negative direction of the global-coordinate system. That is, the positive direction of a w-axis is opposite in direction to the gravity vector.

The gravity vector G is resolved, which is conducted based on the attitude of the tablet 100, into the components of the three axes (Xg, Yg, and Zg), and those values are detected by the three-axis acceleration sensor. A vector that can be obtained by projecting the gravity vector G onto an x-y plane is determined to be a vector Gxy. The angle which the vector Gxy forms with the x-axis is determined to be an angle θ. The angle which the vector Gxy forms with the gravity vector G is determined to be an angle φ. The angle φ represents a degree indicating how much the display screen is tilted with reference to the gravity vector (that is, a vertical direction). The angle θ represents the direction of the tilt relative to the x-axis. The angle θ and the angle φ can be obtained based on the output values of the x-, y-, and z-axes of the acceleration sensor, as will be described later.

A u-v plane of the global-coordinate system agrees with a horizontal plane. A vector that can be obtained by projecting the normal vector N onto the u-v plane is determined to be a vector Nuv. The angle formed between the vector Nuv and the normal vector N agrees with the angle φ. The angle which the vector Nuv forms with a u-axis agrees with the angle θ.

Thus, in the first place, the angle θ is found based on the outputs of the acceleration sensor. On the other hand, the angle between the vector Nuv obtained by projecting the normal vector N onto the u-v plane and the u-axis becomes identical to the angle θ. Consequently, the u-axis is thus determined.

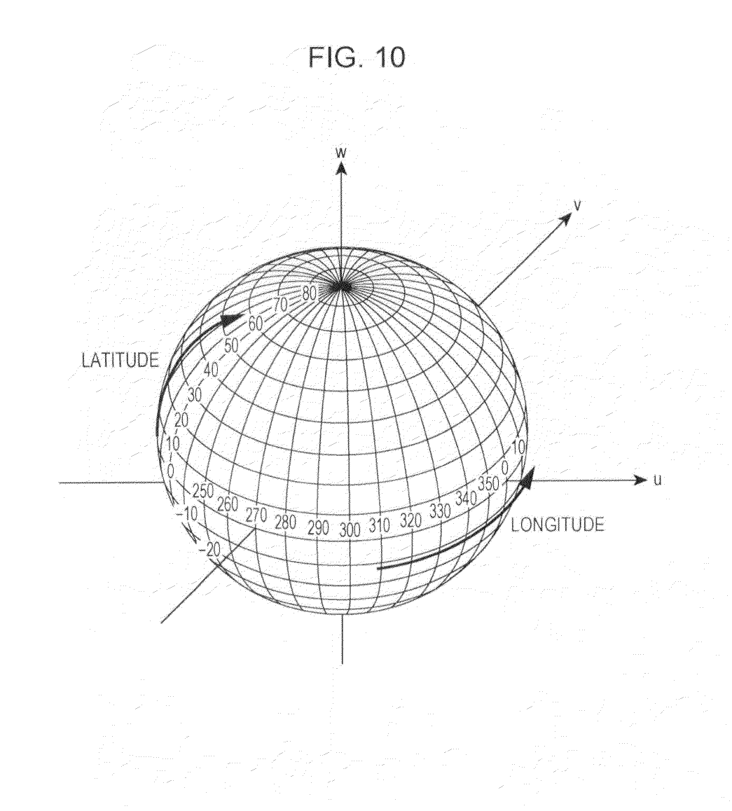

Here, a three-dimensional map diagram illustrating the global-coordinate system represented as a globe is shown in FIG. 10. A coordinate point defined within the coordinate system can be represented as latitude and longitude values that are shown on a globe map. The latitude value includes the range of from 0° to ±90° relative to the v-axis direction, and the longitude value includes the range of from 0° to 360° (or from 0° to)±180° relative to the u-axis positive direction.

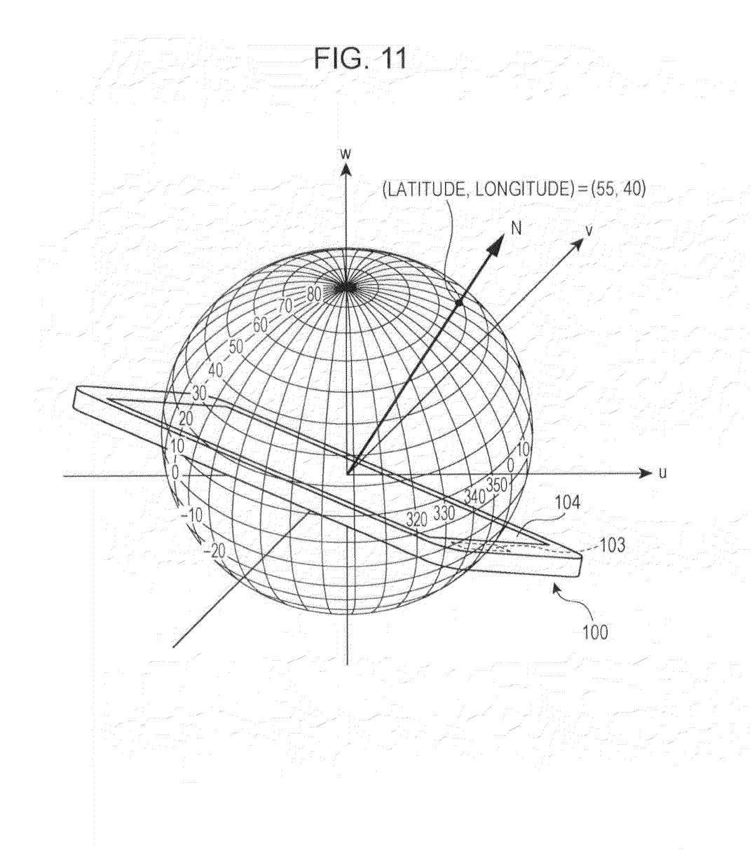

As illustrated in FIG. 11, the above-described normal vector N representing the attitude of the tablet 100 is uniquely represented as the values of a latitude (the angle φ) and a longitude (the angle θ) of the globe representing the global-coordinate system. That is, the latitude and the longitude of the normal vector N of the display screen are used, essentially, to determine the attitude of the nearly rectangular tablet (the display screen) in regard to the gravity vector G, and represented as the angle θ and the angle φ.

The angle θ formed between the vector Gxy that can be obtained by projecting the gravity vector G onto the x-y plane and the x-axis can be calculated according to the following equation (1).

tan θ=Yg/Xg (1)

Here, Xg and Yg are output values of the x- and y-axes, which are obtained by the acceleration sensor.

Likewise, the angle φ formed between the vector Gxy and the gravity vector G can be calculated according to the following equation (2).

Zg·cos φ=√(Xg·Xg+Yg·Yg) (2)

Here, Xg, Yg, and Zg are output values of the x-, y-, and z-axes, which are obtained by the acceleration sensor.

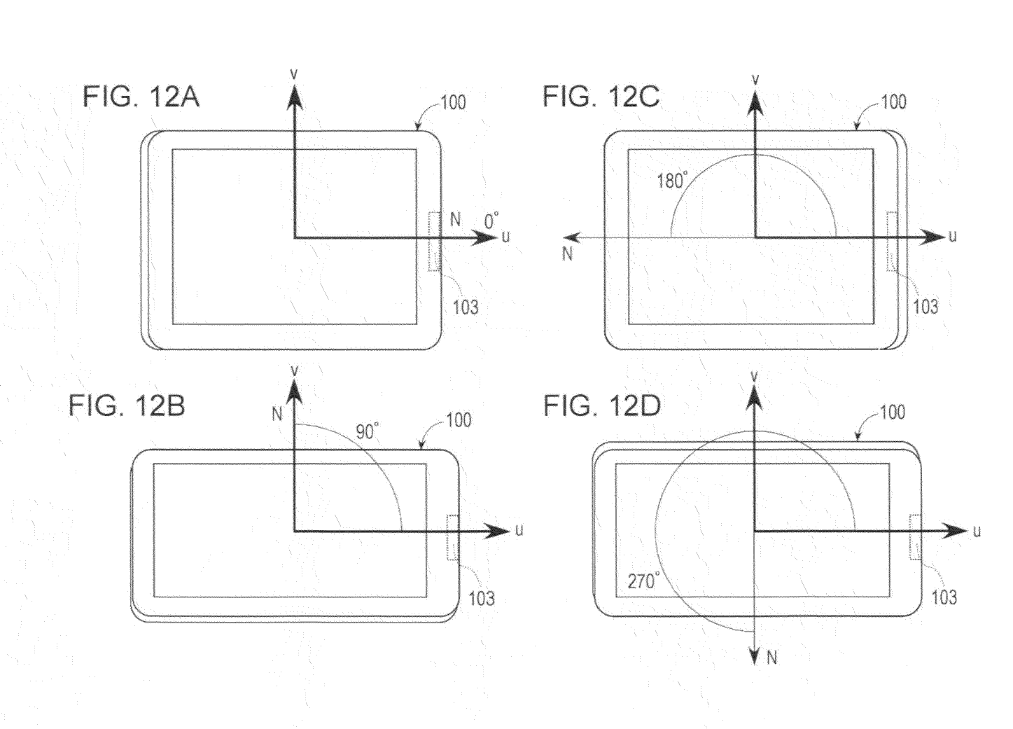

FIGS. 12A to 12D are diagrams that are provided to describe the longitudes of the normal vector N of the display screen of the tablet, and correspond to longitudes 0°, 90°, 180°, and 270°, respectively. The longitude corresponds to the direction in which the display screen of the tablet 100 is tilted, where the display screen is viewed from a vertically upward direction (the north-pole direction).

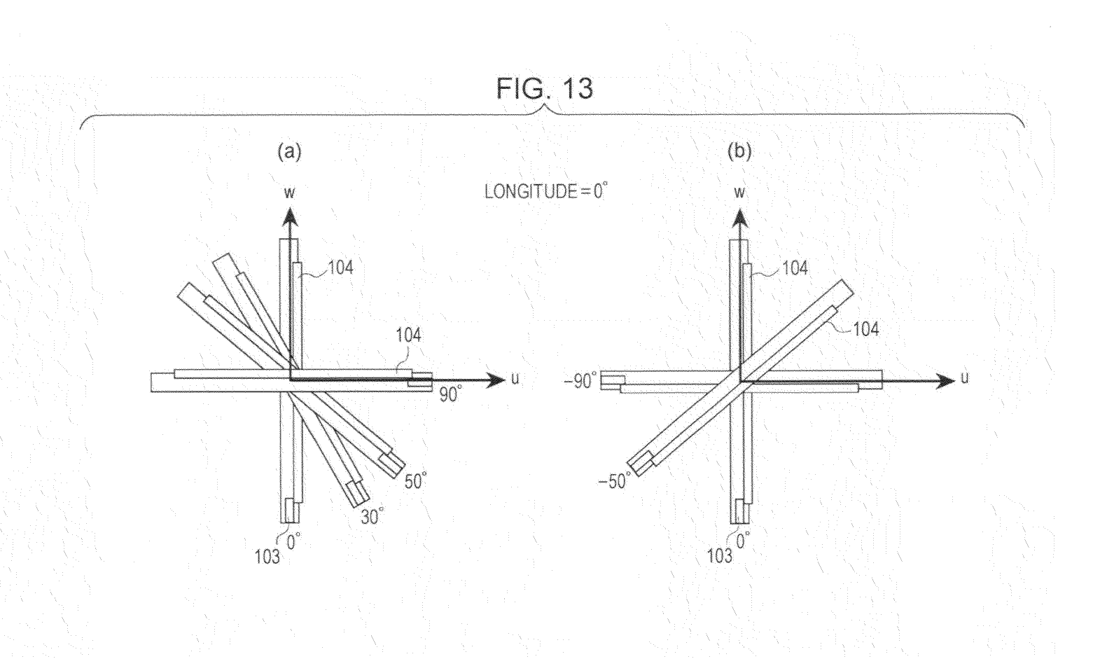

FIGS. 13, 14, 15, and 16 are diagrams that are provided to describe the latitudes of the normal vector of the display screen of the tablet 100 according to the present embodiment. The latitude corresponds to an angle at which the tablet 100 is rotated in a u-w plane around the v-axis of the tablet 100.

Figure profiles of the tablet assuming the attitudes corresponding to various latitudes, where the longitude is 0°. When the longitude is 0°, latitude 0° is obtained in the state where the display screen faces in the u-axis positive direction and the antenna 103 is positioned in the w-axis negative direction. The attitude corresponds to the fact that the normal vector of the display screen points in a horizontal direction. When the normal vector points in the w-axis positive direction (vertically upward direction), latitude 90° is obtained. In FIG. 13A, the attitudes of the tablet, which are assumed at latitudes 30° and 50° between latitudes 0° and 90°, are illustrated.

Parts A and B of FIG. 13 illustrates attitudes of the tablet, which are assumed at latitudes −90° and −50°, where the longitude is 0°. At latitude −90°, the display screen faces in a vertically downward direction and the antenna 103 is positioned in the negative direction of the u-axis. Latitude −50° corresponds to a position midway between latitudes 0° and −90°.

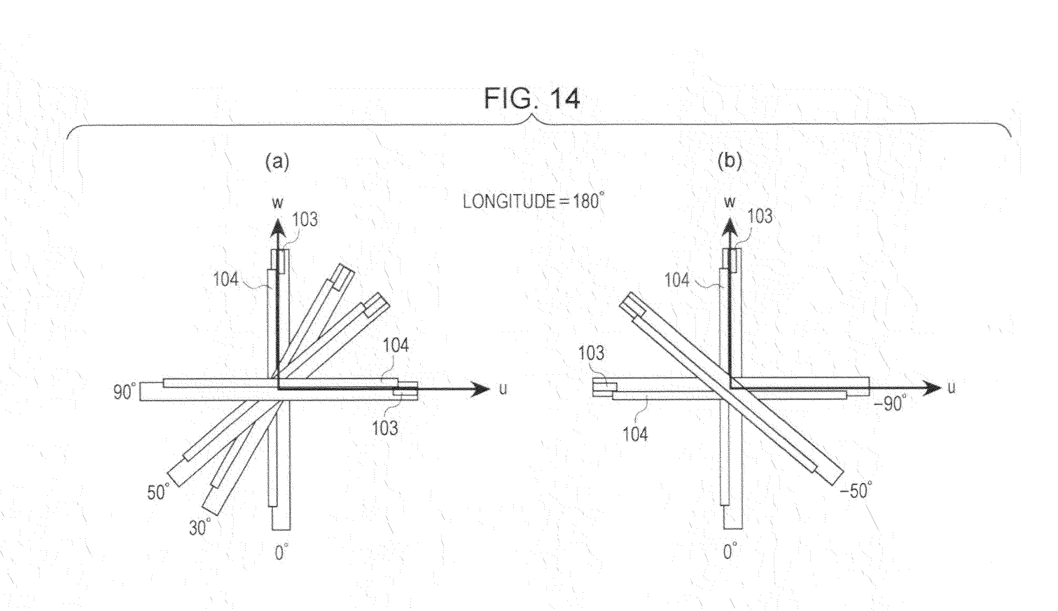

Parts A and B of FIG. 14 are profiles of the tablet assuming the attitudes corresponding to various latitudes, where the longitude is 180°. When the longitude is 180°, latitude 0° is obtained in the state where the display screen faces in the u-axis negative direction and the antenna 103 is positioned in the w-axis positive direction. The attitude corresponds to the fact that the normal vector of the display screen points in a horizontal direction. When the normal vector points in the w-axis positive direction (vertically upward direction), latitude 90° is obtained. The illustrated attitudes of the tablet are assumed at latitudes 30° and 50° between latitudes 0° and 90°.

Parts A and B of FIG. 14 illustrate attitudes of the tablet, which are assumed at latitudes −90° and −50°, where the longitude is 180°. At latitude −90°, the display screen faces in a vertically downward direction and the antenna 103 is positioned in the negative direction of the u-axis. Latitude −50° corresponds to a position midway between latitudes 0° and −90°.

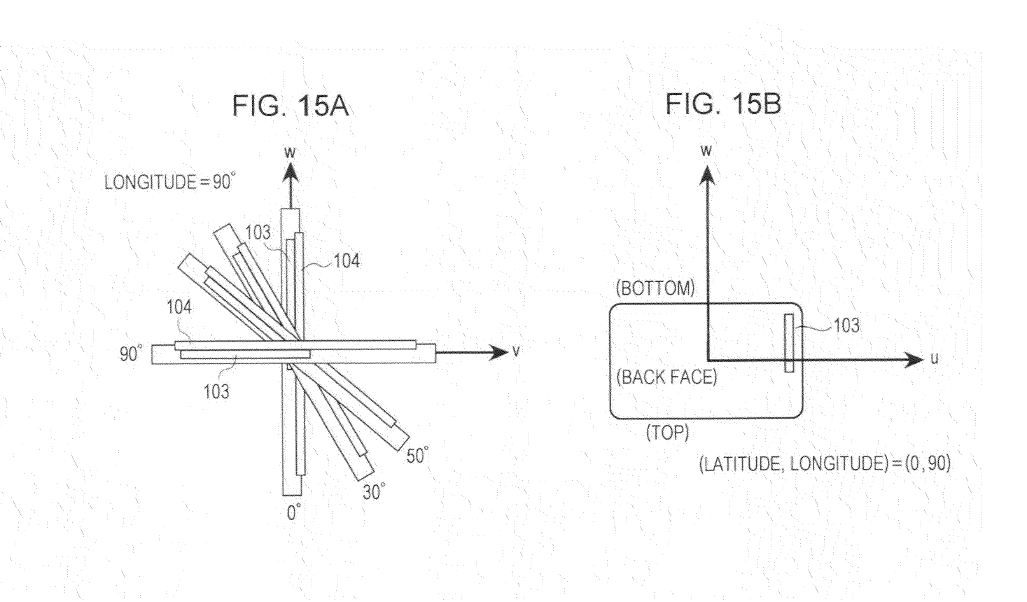

FIGS. 15A and 15B illustrate a profile of the tablet and a rear elevation thereof, where longitude 90° is obtained. As illustrated in FIG. 15A, latitude 0° is obtained in the state where the display screen faces in the v-axis positive direction and the antenna 103 extends in a direction which is almost orthogonal to the u-axis, where latitude 90° is obtained. The attitude corresponds to the fact that the normal vector of the display screen points in a horizontal direction. Latitude 90° is obtained when the normal vector points in the w-axis positive direction (vertically upward direction). The illustrated attitudes of the tablet are assumed at latitudes 30° and 50° between latitudes 0° and 90°.

FIG. 15B illustrates attitudes of the tablet, which is assumed at latitude 0° and longitude 90°. This diagram is obtained by viewing from the v-axis positive direction, and shows the rear of the tablet.

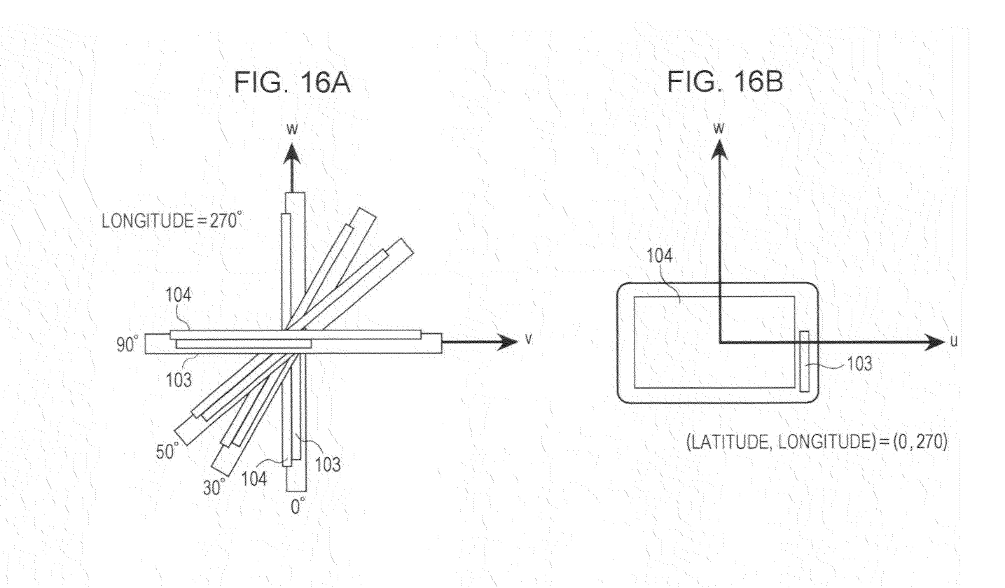

FIGS. 16A and 16B illustrate a profile of the tablet and an elevation thereof, where longitude 270° is obtained. As illustrated in FIG. 16A, latitude 0° is obtained in the state where the display screen faces in the v-axis negative direction and the antenna 103 extends in a direction which is almost orthogonal to the u-axis, where longitude 270° is obtained. The attitude corresponds to the fact that the normal vector of the display screen points in a horizontal direction. Latitude 90° is obtained when the normal vector points in the w-axis positive direction (vertically upward direction). The illustrated attitudes of the tablet are assumed at latitudes 30° and 50° between latitudes 0° and 90°.

FIG. 16B illustrates an attitude of the tablet, which is assumed at latitude 0° and longitude 270°. This diagram is obtained by viewing from the v-axis positive direction, and shows a face of the tablet (the display screen).

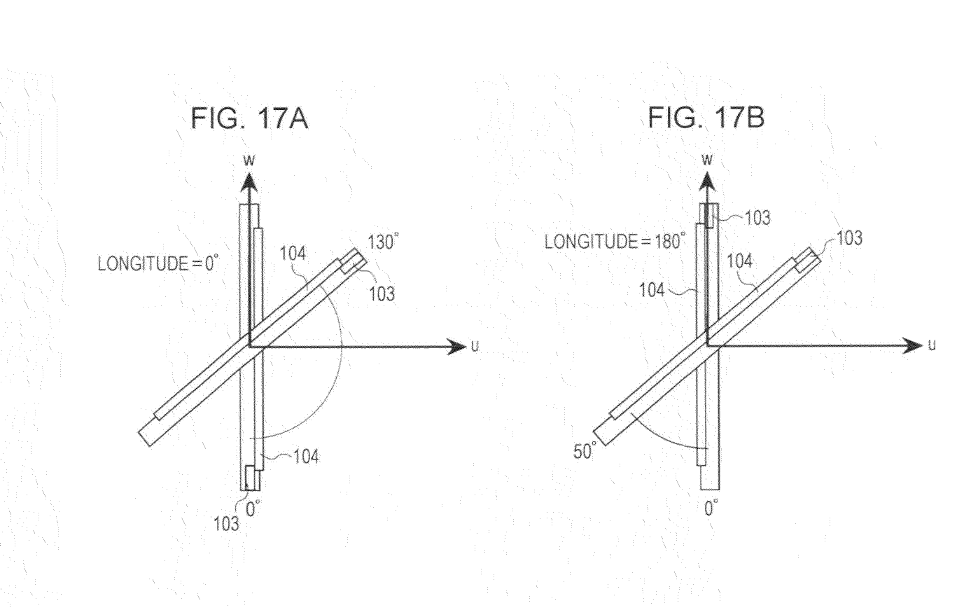

FIG. 17A illustrates the case where the latitude is changed from 0° to 130°, where longitude 0° is obtained. FIG. 17B illustrates the case where the latitude is changed from 0° to −50°, where longitude 180° is obtained. The latitude falls within the range of from −90° to +90°, the attitude represented as (latitude, longitude)=(130, 0) of FIG. 17A is equivalent to that represented as (latitude, longitude)=(50, 180) of FIG. 17(b).

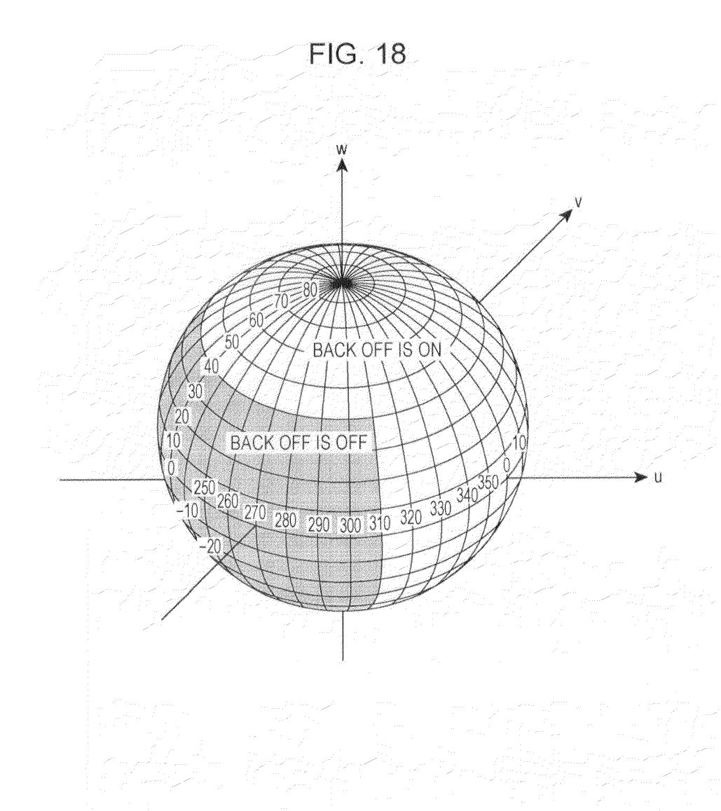

FIG. 18 illustrates the area where the back-off being turned on (enabled) and the area where the back-off being turned off (disabled), which are allocated to the globe representing the global-coordinate system with the values of latitudes and longitudes as illustrated in FIG. 10. It is equivalent to the allocation of the back-off being turned on and the back-off being turned off to the individual attitudes of the tablet 100.

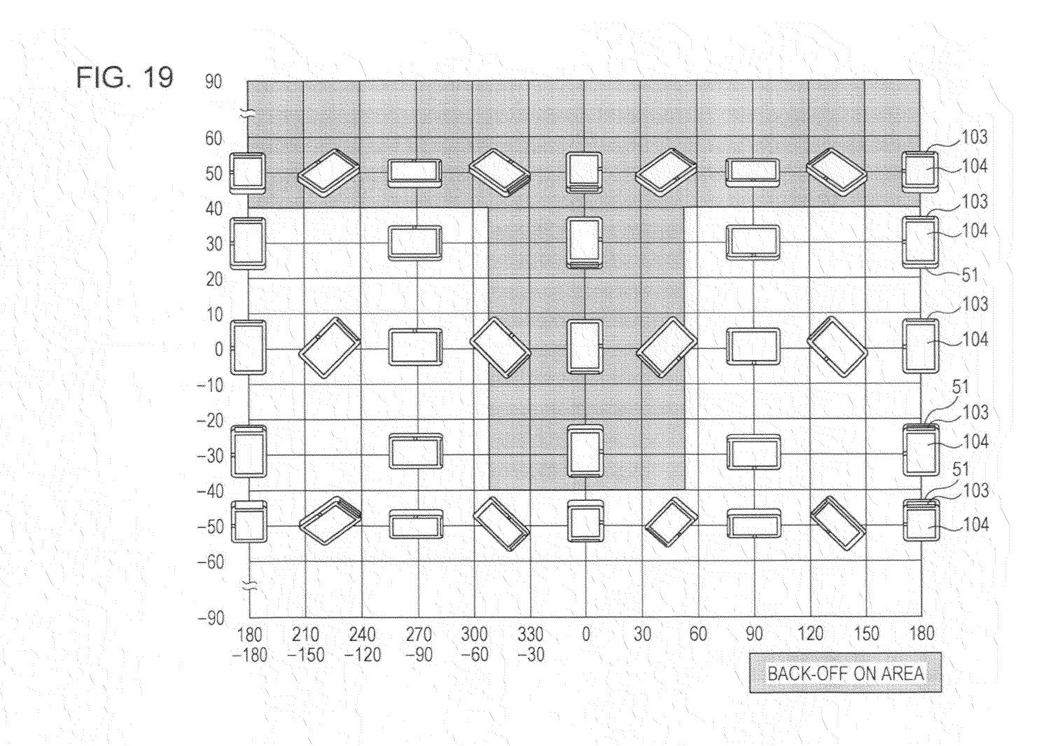

FIG. 19 is a two-dimensional map obtained by projecting a three-dimensional map of FIG. 18 onto two-dimensional map. The attitudes of schematic tablets are illustrated as external views thereof at plural latitude•longitude positions that are shown in the two-dimensional map diagram. In this diagram, the tilt of the tablet is indicated by a thickness 51 added to an edge side.

A dark area shown in the two-dimensional map diagram of FIG. 19 indicates that the back-off is turned on when the latitude and the longitude fall within that area according to the present embodiment. A light area indicates that the back-off is turned off when the latitude and the longitude fall within that area. In this example, the back-off is turned off irrespective of the longitude in an area where the latitude is 40° or more. The area corresponds to an attitude assumed when the display screen of the tablet 100 faces in a vertically-upward direction. The attitude corresponds to an attitude assumed when the user places the tablet on the knees for use. In that case, it is determined that the SAR needs to be considered for each latitude, and the back-off is turned on.

An area where the latitude is from −40° to 40° of FIG. 19 corresponds to an attitude assumed when the user holds the tablet in the portrait position. In that area, the latitude falls within the range of ±50°, the antenna is positioned under the tablet, and the longitudinal direction thereof is horizontal or a direction close thereto. It is determined that the SAR needs to be considered for such an attitude, and the back-off is turned on.

In an area where the latitude is from −40° to −90°, the display screen is in a face-down status or a status close thereto, and it is therefore determined not to be a status of being used by the user, so that the back-off is turned on at every longitude.

When the latitude is 0°, the normal vector set in the global-coordinate system is not changed when the tablet is rotated around the normal vector of the display screen while keeping the display screen directed toward the front. However, it should be noted that the value of the angle θ is changed and the longitude is changed, in actuality, due to a change in the value of x/y of the output of the acceleration sensor. As a consequence, the direction of the normal vector is uniquely identified based on the angle φ and the angle θ. Accordingly, the attitude of the tablet is also uniquely identified based on the angle φ and the angle θ.

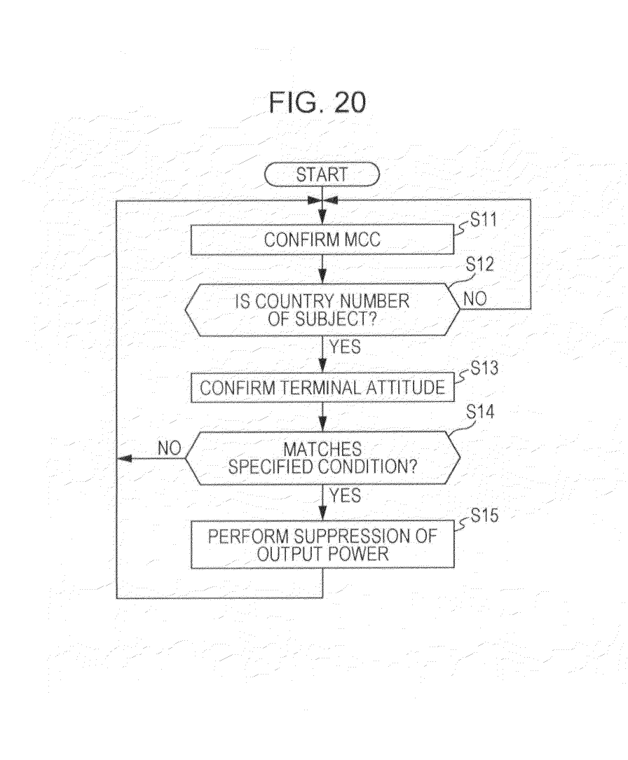

FIG. 20 illustrates a flowchart exhibiting exemplary processing procedures of the control unit 101 of the tablet 100 according to the present embodiment.

The necessity or lack thereof of the back-off may vary based not only on the attitude of the tablet 100, but also on the limits of a country. Therefore, processing of FIG. 20 includes the step of determining an MCC (Mobile Country Code). The MCC denotes a code representing a country (country number). Usually, a radio communication terminal can make confirmation based on information acquired from a base station at the time of position registration performed for the base station.

In FIG. 20, first, an MCC acquired from the base station is confirmed (S11). It is determined whether or not the confirmed country number becomes a subject for the back-off execution (S12). When the country number is not the subject, the processing returns to step S11.

When the country number is the subject, the current attitude of a terminal (the tablet) is confirmed (S13). When the confirmed attitude does not match the above-described specified condition (S14, No), the processing returns to step S11. When the confirmed attitude matches the specified condition, the setting of the radio communication unit 102 is adjusted to perform the suppression of output power (S15). The suppression of the output power includes changing the maximum value of the output power according to the present embodiment. After that, the processing returns to step S11.

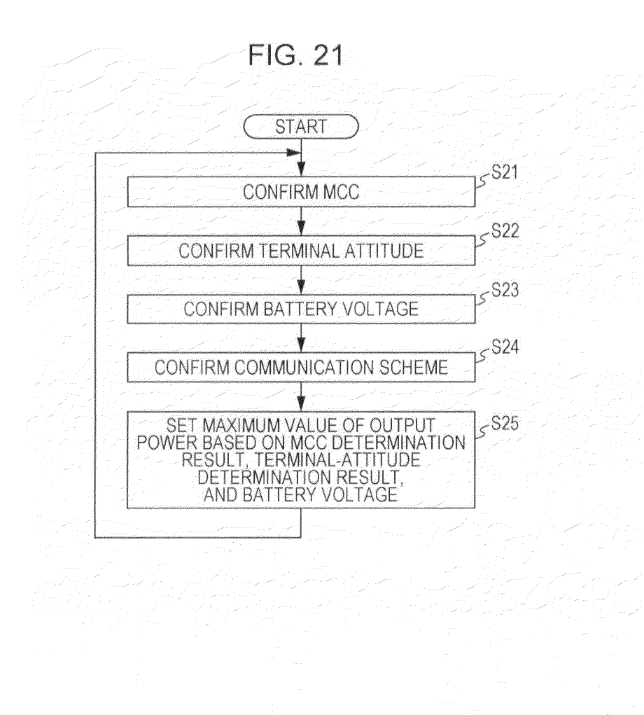

FIG. 21 illustrates a flowchart exhibiting other exemplary processing procedures of the control unit 101 of the tablet 100 according to the present embodiment. The maximum value of the output power of the radio communication unit 102 often needs to be changed in accordance with the voltage value of the battery. Processing of FIG. 21 is performed to set the maximum power of the output power in consideration of the voltage value of the battery in relation to the determination of the necessity or lack thereof of the back-off.

First, the MCC is confirmed (S21). Then, the current attitude of the terminal is confirmed (S22). Next, the current battery voltage is confirmed (S23). Further, a communication scheme for use is confirmed (S24).

Then, the maximum value of the output power is set based on the MCC determination result, the terminal-attitude determination result, the battery voltage, and the communication scheme (S25).

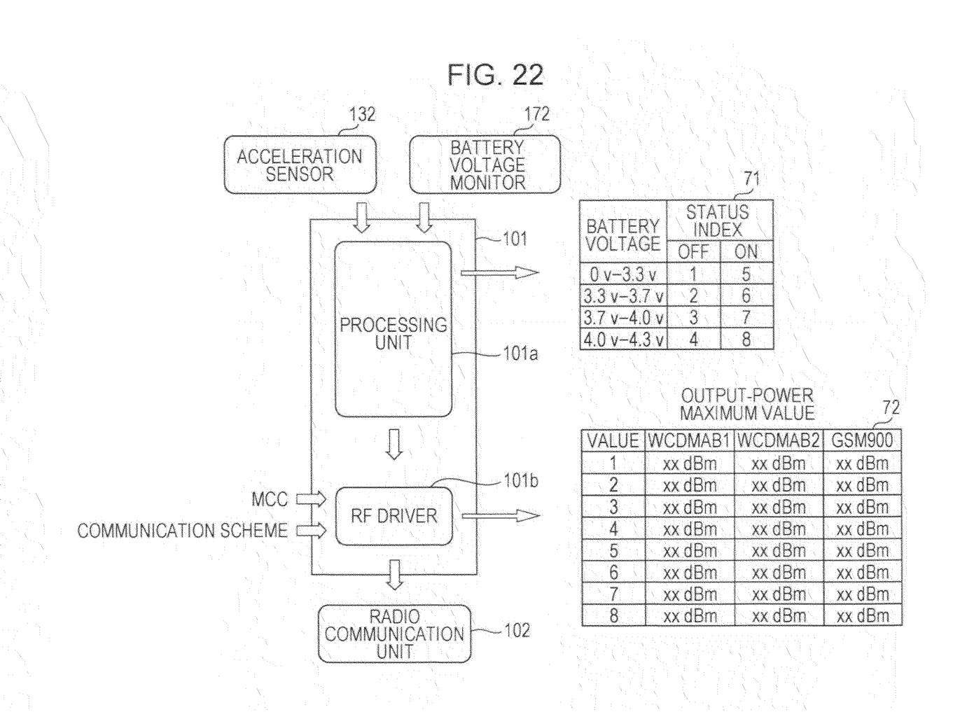

FIG. 22 illustrates specific functions that are provided to determine the maximum value of the output power as a block diagram. In this example, a method of determining the maximum value of the output power of the radio communication unit 102 based on the output of the acceleration sensor 132, the output of the battery voltage monitor 172, and the confirmed MCC will be described correspondingly to the processing of FIG. 21.

During the processing, two data tables 71 and 72 are used. These data tables are nonvolatilely stored in a memory 106, for example. The data table 71 is a table defining the status indexes corresponding to battery voltages. Statuses that are achieved when the back-off is turned on and off are defined as index values (numbers) in accordance with the ranges of detected battery voltages.

In the example of the diagram, for the range of voltages of from 0 to 3.3v, the status index value of the back-off OFF time is determined to be 1, and that of the ON time is determined to be 5. For the range of voltages of from 3.3 to 3.7v, the status index value of the back-off OFF time is determined to be 2, and that of the ON time is determined to be 6. For the range of voltages of from 3.7 to 4.0v, the status index value of the back-off OFF time is determined to be 3, and that of the ON time is determined to be 7. For the range of voltages of from 4.0 to 4.3v, the status index value of the back-off OFF time is determined to be 4, and that of the ON time is determined to be 8. The boundaries and the number of those voltage ranges, and the allocated index values are illustrated just for the sake of exemplification and are not limited thereto.

The data table 72 is a table where output-power maximum values (dBm values) that are determined for individual communication schemes are allocated correspondingly to the status index values of the data table 71. Although WCDMA B1, WCDMA B2, and GSM900 (GSM is a registered trademark) are provided as the communication scheme in this example, the communication scheme is not limited thereto. In comparison with the maximum values that are allocated to the status index values 1 to 4 of the back-off OFF time, the maximum values corresponding thereto, respectively, which are allocated to the status index values 5 to 8 of the back-off ON time, are set to be smaller. As to the battery voltage, usually, the output-power maximum value is reduced when the voltage value is small.

Through the use of the data tables 71 and 72, the control unit 101 executes the processing of the present embodiment. That is, first, a processing unit 10a provided in the control unit 101 detects the current attitude of the current tablet and determines the necessity or lack thereof (ON/OFF) of the back-off based on the MCC confirmation result and the output of the acceleration sensor 132. Then, on the basis of the determination result and the output of the battery voltage monitor 172, the status index value corresponding to the battery voltage range is obtained with reference to the data table 71. After that, the communication scheme is confirmed, and the radio communication unit 102 is controlled by an RF driver 131b based on the output-power maximum value associated with the status index value and the communication scheme with reference to the data table 72.

When a radio communication terminal is expected to be used only in a specified country, no consideration needs to be given to the MCC. Further, when the radio communication terminal is expected to be used only under a specified communication scheme, no consideration needs to be given to the communication scheme.

According to the above-described embodiments of the present invention, the necessity or lack thereof the back-off is determined based on the attitude of the mobile radio terminal, which allows for suppressing the output power of the radio communication unit with reliability in a user's use status where the SAR becomes a problem.

As an attitude detection unit configured to detect the current attitude, an acceleration sensor existing in a mobile radio terminal is used, so that no additional hardware component including the proximity sensor, etc. achieved through existing technologies is required.

Further, since the attitude detection unit can be provided on the cabinet at an arbitrary position, it becomes possible to avoid the detrimental effect of affecting the antenna characteristics as is the case with the proximity sensor.

Further, even though the proximity sensor often reacts to materials other than a human body, for example, a terminal cover, paper placed on a desk, and so forth, the attitude detection unit causes no such detrimental effect.

As described above, an embodiment of the present invention includes the following various modes.

(1) A mobile radio terminal includes

a cabinet;

an attitude detector that is installed in the cabinet and detects a current attitude of the cabinet;

a wireless transceiver that includes a transmitter and a receiver that respectively transmit and receive radio frequency signals via an antenna; and

a control circuitry that suppresses radiated output power of the transmitter in accordance with a current attitude of the cabinet detected by the attitude detector.

(2) The mobile radio terminal according to (1), wherein the attitude detector includes a three-axis acceleration sensor, and the current attitude is detected based on an output of the three-axis acceleration sensor.

(3) The mobile radio terminal according to (2), wherein the attitude detector obtains two angles φ and θ based on x-axis, y-axis, and z-axis outputs of the three-axis acceleration sensor, and the control circuitry determines a necessity or a lack of necessity to suppress the radiated output power of the transmitter in accordance with a combination of angle values of angles φ and θ.

(4) The mobile radio terminal according to (1), wherein the control circuitry determines whether or not to suppress the radiated output power of the transmitter based on whether or not the current attitude of the cabinet, as detected by the attitude detector, matches a predetermined attitude condition.

(5) The mobile radio terminal according to (1), wherein the control circuitry determines whether or not to suppress the radiated output power of the transmitter based on a mobile country code received by the receiver from a radio base station.

(6) The mobile radio terminal according to (1), wherein the mobile radio terminal is battery operated, and

the control circuitry determines a maximum value of the radiated output power based on whether the control circuitry determines whether there is a necessity or a lack of necessity to suppress the radiated output power of the transmitter and a current voltage value of the battery.

(7) The mobile radio terminal according to (6), wherein the control circuitry further determines the maximum value of the radiated output power of the transmitter based on a communication scheme of the wireless transceiver.

(8) A method of reducing specific absorption rate (SAR) in a mobile radio terminal, the method including:

detecting a current attitude of a cabinet of the mobile radio terminal with an attitude detector installed in the cabinet;

transmitting radio frequency signals with a transmitter and an antenna and receiving radio frequency signals with a receiver and the antenna, and

controllably suppressing a radiated output power of the transmitter with a control circuitry in accordance with a current attitude of the cabinet as detected by the attitude detector.

The method of (8), wherein the method employs the features of (2) through (7).

(9) A non-transitory computer readable storage medium having computer readable instructions stored thereon that when executed by a processor perform a method of reducing specific absorption rate (SAR) in a mobile radio terminal, the method including:

detecting a current attitude of a cabinet of the mobile radio terminal with an attitude detector installed in the cabinet;

transmitting radio frequency signals with a transmitter and an antenna and receiving radio frequency signals with a receiver and the antenna, and

controllably suppressing a radiated output power of the transmitter with a control circuitry in accordance with a current attitude of the cabinet as detected by the attitude detector.

The computer readable storage medium of (9), which employs the features of (2) through (6).

Although preferred embodiments of the present invention have been described above, different variations and changes other than those described above can be made. That is, it should be understood by those skilled in the art that various modifications, combinations, and other embodiments may occur depending on design and/or other factors insofar as they are within the scope of the claim or the equivalent thereof, as a matter of course.

For example, the size, the shape, the arrangement, etc. of the main antenna, which are illustrated in the diagrams and the above descriptions, are for the sake of exemplification and are not particularly limited thereto. The range of latitudes•longitudes, where the back-off should be turned on, may vary based on the position or the arrangement of the main antenna. The specific angle values are for the sake of exemplification, and are not limited to the above-described values.

### REFERENCE SIGNS LIST

50: cabinet, 60: user, 61: phantom, 71, 72: data table, 100: tablet, 101: control unit (control circuitry), 102: radio communication unit (wireless transceiver), 103: main antenna, 104: display unit, 105: operation unit, 106: memory, 110: speaker, 121: earphone terminal, 132: acceleration sensor, 150: control line, 160: data line, 170: battery, 172: battery voltage monitor, 174: imaging control unit, 175: camera unit, 176: GPS control unit, 177: GPS antenna, 178: sub-antenna

1. A mobile radio terminal comprising:
a cabinet;
an attitude detector that is installed in the cabinet and detects a current attitude of the cabinet;
a wireless transceiver that includes a transmitter and a receiver that respectively transmit and receive radio frequency signals via an antenna; and
a control circuitry that suppresses radiated output power of the transmitter in accordance with a current attitude of the cabinet detected by the attitude detector.

2. The mobile radio terminal according to claim 1, wherein the attitude detector includes a three-axis acceleration sensor, and the current attitude is detected based on an output of the three-axis acceleration sensor.

3. The mobile radio terminal according to claim 2, wherein the attitude detector obtains two angles φ and θ based on x-axis, y-axis, and z-axis outputs of the three-axis acceleration sensor, and the control circuitry determines a necessity or a lack of necessity to suppress the radiated output power of the transmitter in accordance with a combination of angle values of angles φ and θ.

4. The mobile radio terminal according to claim 1, wherein the control circuitry determines whether or not to suppress the radiated output power of the transmitter based on whether or not the current attitude of the cabinet, as detected by the attitude detector, matches a predetermined attitude condition.

5. The mobile radio terminal according to claim 1, wherein the control circuitry determines whether or not to suppress the radiated output power of the transmitter based on a mobile country code received by the receiver from a radio base station.

6. The mobile radio terminal according to claim 1, wherein the mobile radio terminal is battery operated, and
the control circuitry determines a maximum value of the radiated output power based on whether the control circuitry determines whether there is a necessity or a lack of necessity to suppress the radiated output power of the transmitter and a current voltage value of the battery.

7. The mobile radio terminal according to claim 6, wherein the control circuitry further determines the maximum value of the radiated output power of the transmitter based on a communication scheme of the wireless transceiver.

8. A method of reducing specific absorption rate (SAR) in a mobile radio terminal, the method comprising:
detecting a current attitude of a cabinet of the mobile radio terminal with an attitude detector installed in the cabinet;
transmitting radio frequency signals with a transmitter and an antenna and receiving radio frequency signals with a receiver and the antenna, and
controllably suppressing a radiated output power of the transmitter with a control circuitry in accordance with a current attitude of the cabinet as detected by the attitude detector.

9. The method according to claim 8, wherein the detecting includes detecting the current attitude of the cabinet with an output of a three-axis acceleration sensor.

10. The method according to claim 9, wherein the detecting further includes obtaining two angles φ and θ based on x-axis, y-axis, and z-axis outputs of the three-axis acceleration sensor, and
the controllably suppressing includes combining angle values of angles φ and θ and determining a necessity or a lack of necessity to suppress the radiated output power of the transmitter in accordance with a combined angle value.

11. The method according to claim 8, wherein
the controllably suppressing includes determining with the control circuitry whether or not to suppress the radiated output power of the transmitter based on whether or not the current attitude of the cabinet matches a predetermined attitude condition.

12. The method according to claim 8, further comprising:
receiving via the receiver a mobile country code from a radio base station, wherein
the controllably suppressing includes determining with the control circuitry whether or not to suppress the radiated output power of the transmitter based on the mobile country code received by the receiver.

13. The method according to claim 8, further comprising:
powering the mobile radio terminal with a battery; and
determining with the control circuitry a maximum value of the radiated output power based on whether the control circuitry determines whether there is a necessity or a lack of necessity to suppress the radiated output power of the transmitter and a current voltage value of the battery.

14. The method according to claim 13, further comprising
determining with the control circuitry the maximum value of the radiated output power of the transmitter based on a communication scheme of the mobile radio terminal.

15. A non-transitory computer readable storage medium having computer readable instructions stored thereon that when executed by a processor perform a method of reducing specific absorption rate (SAR) in a mobile radio terminal, the method comprising:
detecting a current attitude of a cabinet of the mobile radio terminal with an attitude detector installed in the cabinet;
transmitting radio frequency signals with a transmitter and an antenna and receiving radio frequency signals with a receiver and the antenna, and
controllably suppressing a radiated output power of the transmitter with a control circuitry in accordance with a current attitude of the cabinet as detected by the attitude detector.

16. The non-transitory computer readable medium according to claim 15, wherein the detecting includes detecting the current attitude of the cabinet with an output of a three-axis acceleration sensor.

17. The non-transitory computer readable medium according to claim 16, wherein
the detecting further includes obtaining two angles φ and θ based on x-axis, y-axis, and z-axis outputs of the three-axis acceleration sensor, and
the controllably suppressing includes combining angle values of angles φ and θ and determining a necessity or a lack of necessity to suppress the radiated output power of the transmitter in accordance with a combined angle value.

18. The non-transitory computer readable medium according to claim 15, wherein
the controllably suppressing includes determining with the control circuitry whether or not to suppress the radiated output power of the transmitter based on whether or not the current attitude of the cabinet matches a predetermined attitude condition.

19. The non-transitory computer readable medium according to claim 15, wherein the method further comprising:
receiving via the receiver a mobile country code from a radio base station, wherein
the controllably suppressing includes determining with the control circuitry whether or not to suppress the radiated output power of the transmitter based on the mobile country code received by the receiver.

20. The non-transitory computer readable medium according to claim 15, wherein the method further comprising:
powering the mobile radio terminal with a battery; and
determining with the control circuitry a maximum value of the radiated output power based on whether the control circuitry determines whether there is a necessity or a lack of necessity to suppress the radiated output power of the transmitter and a current voltage value of the battery.
